(19) United States
(12) Patent Application Publication
(10) Pub. No.: US 2005/0238060 A1
(43) Pub. Date: Oct. 27, 2005

(54) Synchronizing to GSM RF downlink signal frame timing

(76) Inventors: Thomas L. Kuntz, Portland, OR (US); Thomas A. Elliott, Tigard, OR (US)

Correspondence Address: TEKTRONIX, INC.;Francis I. Gray, 50-LAW, P.O. BOX 500, BEAVERTON, OR, 97077, US

(21) Appl. No.: 10/831,670

(22) Filed: Apr. 23, 2004

(51) Int. Cl. H04B 7/212; H04J 3/06

(52) U.S. Cl. 370/509; 370/350

(57) ABSTRACT

A method of synchronizing to GSM RF downlink signal frame timing includes acquiring a continuous sample data record from a base RF channel (BCCH) of the RF downlink signal that encompasses multiple frames of the GSM RF downlink signal to guarantee inclusion of synchronization frames. The location of a frequency correction burst within the sample data record is searched for and, once the frequency correction burst location is found, a synchronization burst is searched for within a limited time range about a predicted location to determine a precise indication of frame location. With frames precisely located, data may be extracted from any desired slot of the frames from the continuous sample data record, or of frames in a continuous sample data record acquired from a related measurement channel, for further measurement processing.

### BACKGROUND OF THE INVENTION

The present invention relates to testing of GSM (Global System for Mobile communications) signals; and more particularly to a method of synchronizing to GSM RF (Radio Frequency) downlink signal frame timing.

A Base Transceiver Station (BTS) in a GSM wireless cellular communication system transmits an RF signal, the “downlink” signal, formatted using Time Domain Multiplex Access (TDMA) which is a technique for multiplexing multiple users' information onto a single RF carrier by splitting the carrier into timeslots. The downlink signal has a frame structure of eight timeslots, each of which may be assigned to carry system or user information. Each sector of three of a GSM BTS must transmit a “base RF channel” (BCCH channel) downlink signal which uses the first slot—slot 0— of every frame to carry system synchronization and broadcast information. Mobile units use the base channel to acquire initial synchronization to the BTS. The full synchronization process involves multiple steps of finding and decoding special information bursts on slot 0 of the BCCH channel.

With the addition to GSM of enhanced modulation techniques (“EDGE”), network operators have new needs for testing the BTS RF output. EDGE uses a new type of modulation—8 Phase Shift Keying (PSK)—which carries more data than the original GSM modulation (GMSK) in the same time and bandwidth. EDGE is a packet-based system where data is transmitted only as needed. Operators need to be able to measure the RF signal parameters, such as power, signal quality, etc., on specific slots of the transmitted TDMA signal, including slots that may be assigned EDGE packets. Therefore it is important for a measurement device or test instrument to be able to determine the frame timing of the GSM signal to make measurements on the slots that the user identifies as being of interest. A test device that synchronizes to the TDMA signal frame timing uses the frame timing to identify slots of interest and measures signal parameters in the identified slots to provide valuable information to operators.

However currently GSM test instrument capabilities have straddled the synchronization issue. Some instruments provide slot synchronization, but are not able to identify which slot within the frame is being measured. These instruments use basic attributes of all GSM slots, such as power ramping, to identify the start of a slot, but do not identify its location in the frame. On the other side are full-blown BTS test sets that mimic a mobile handset's ability to synchronize and register with the BTS and are able to completely identify all parts of the TDMA signal. Often these tests are intrusive, requiring the BTS to be removed from service while tests are in progress, causing loss of capacity in the operator's system.

What is desired is a method for a measurement instrument of obtaining frame synchronization, and thus be able to identify slots within the GSM frame, while remaining passive and non-intrusive, allowing the BTS to remain in service while measurements are made.

### BRIEF SUMMARY OF THE INVENTION

Accordingly the present invention provides a method of synchronization to GSM RF downlink signal frame timing by acquiring data from the RF downlink signal that encompasses multiple frames of the GSM RF downlink signal which include synchronization frames. The location of a frequency correction (FC) burst within the acquired data is searched for and, once the frequency correction burst location is found, a synchronization (SY) burst is searched for within a limited time range about a predicted location to determine a precise indication of frame location. With frames precisely located, data may be extracted from any desired slot of the frames for further measurement processing.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a symbolic view of a BCCH channel frame structure.

FIG. 2 is a symbolic view of the relationship between a BCCH channel and a non-BCCH measurement channel.

FIGS. 3a and 3b are a flow chart view of a method of synchronizing to GSM RF downlink signal frame timing according to the present invention.

### DETAILED DESCRIPTION OF THE INVENTION

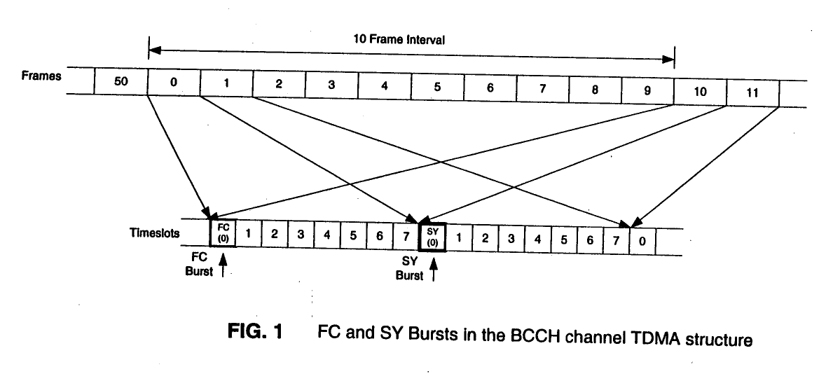

GSM frame synchronization involves sequentially detecting two special types of bursts transmitted in consecutive slot 0s of a broadcast control channel (BCCH) frame structure. The frame structure is described in the GSM system specification, 3GPP TS 05.01, incorporated herein by reference, and illustrated by FIG. 1 where a ten frame “superframe” structure is shown. Frames 0 and 1 of each superframe have a frequency correction (FC) burst and a synchronization (SY) burst in respective slot 0s. To obtain frame synchronization a receiver first detects the FC burst from a continuous sample data record, which gives a “coarse” location of the frame structure as well as providing a carrier frequency offset estimate—see co-pending U.S. patent application Ser. No. 10/734,407, incorporated herein by reference. Using the FC location information, the receiver then computes a location for the SY burst and searches a limited time range about the computed location for the SY burst, which gives a precise indication of frame location when found.

The general process is for the instrument receiver to acquire a continuous sample data record spanning sufficient frames to guarantee that at least one occurrence of the FC and SY bursts in consecutive frames are acquired, and then to search the sample data record for the FC and SY bursts to determine frame alignment. Once frame alignment is found, any slot of a frame may be extracted for further measurement processing, including slots of frames in adjacent frequency channels that are synchronized with the BCCH channel, by computing its location relative to the location of the SY burst in the BCCH channel.

Processing efficiency may be improved when multiple measurement acquisitions are made by using information from a successful frame synchronization detection to aid subsequent acquisitions. If the elapsed time from one signal acquisition to the next is available, the frame synchronization information from the first signal acquisition may be used to predict where the SY burst ought to occur in the second acquisition based on the knowledge of its location in the first acquisition. Then FC detection may be bypassed, and only the SY search done to find fine frame alignment. The newly found SY detection location may then be used in a subsequent acquisition for again predicting the location of the next SY burst.

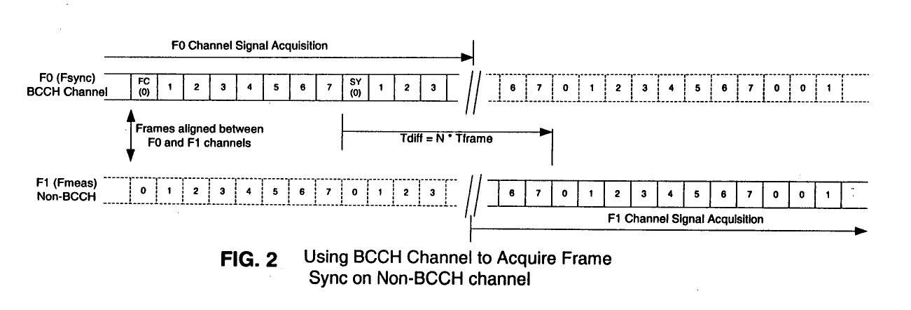

Further, the measurement device may measure signal parameters of specific slots on non-BCCH channels by first acquiring frame synchronization on the BCCH channel, and then acquiring a continuous sample data record from the desired non-BCCH channel. Using “time-stamp” information from each acquisition—the BCCH channel acquisition for frame synchronization and the non-BCCH channel acquisition for measurement—the frame structure in the non-BCCH channel, which doesn't have the FC and SY bursts, may be identified in order to extract the slot data of interest. FIG. 2 shows the BCCH channel (F0) having a given frequency, F_{bcch} or F_{sync}, and a non-BCCH channel (F1) having a given frequency, Fₘₑₐₛ. The frames are aligned between the BCCH and non-BCCH channels at the transmitter, so from the SY time in the BCCH channel a desired slot in the non-BCCH channel may readily be identified.

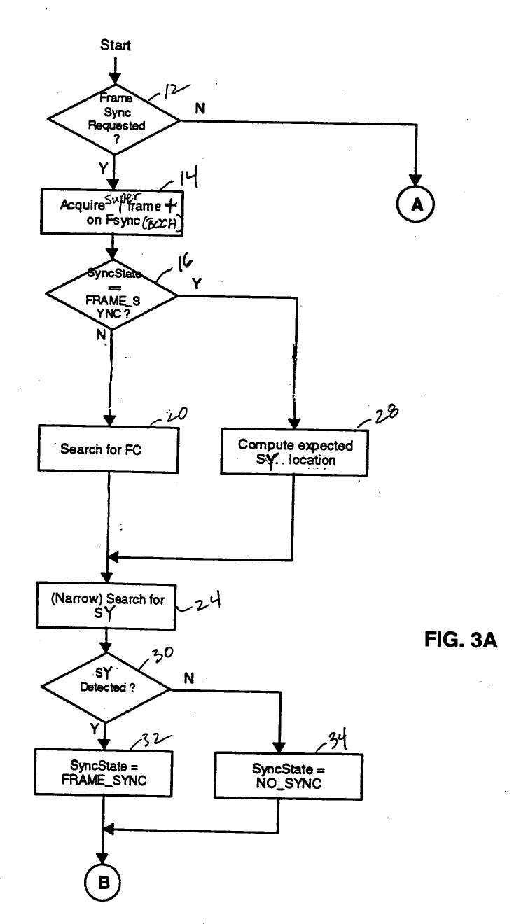

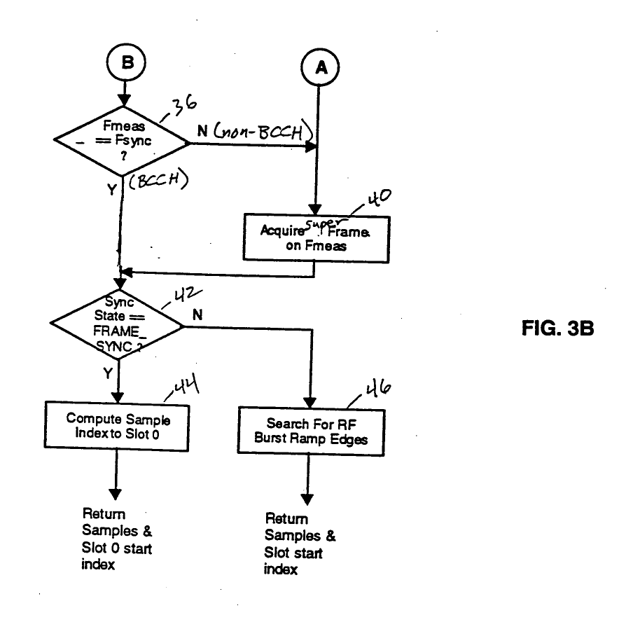

Referring now to FIGS. 3a and 3b an initial test (step 12) asks whether frame synchronization has been requested. If yes, then a continuous sample data record of sufficient length to guarantee that there is at least one occurrence of FC and SY bursts in consecutive frames is acquired from the designated BCCH channel (F_{bcch} is the frequency of the BCCH channel) (step 14), i.e., a “superframe” plus three frames. The Sync State is tested (step 16) to determine whether frame synchronization has been acquired previously. If not, then the sample data record is searched for the FC burst (step 20). The FC search may be a brute force correlation operation across the entire sample data record. The detection of the FC burst simply chooses a sample location that maximizes a correlation function.

If Sync State (step 16) indicates that frame synchronization has previously been acquired, then the expected location for the SY burst is computed (step 28). Once the expected location for SY burst is computed, then a narrow search for the SY burst (step 24) is performed. Detection of the SY burst may be done by correlating the sample data with a reference (ideal) sync burst waveform over a small range centered on the predicted location of the SY burst, as referenced from the detected FC burst. The sample index of the correlation producing the largest squared correlation magnitude is chosen as the location of the SC burst start. The search window or range is set based upon the “uncertainty” in the FC burst location detection, i.e., if FC detection has an uncertainty of +/−10 samples, then the search window is at least this wide around the predicted location and generally wider.

The same method of SC burst detection is used to “verify” frame sync by correlation detection of the SC burst over a small window when a subsequent acquisition is made. In this case the information of the SC burst from the previous acquisition is used to predict where the SC burst should occur in the present acquisition, and the maximum correlation location is found within the search window about the predicted location. If correlation fails to reach a detection threshold, i.e., the SC burst is not detected, then a full synchronization search starting with FC detection is done.

If the SY burst is detected (step 30), Sync State is set to FRAME_SYNC (step 32) to indicate that frame synchronization has been acquired, otherwise Sync State is set to NO_SYNC (step 34) to indicate no frame synchronization was acquired. In any event the current acquisition channel frequency F_{bcch} is checked to see if it is the same as the measurement channel frequency Fₘₑₐₛ (step 36). If not, then a separate acquisition is done on the measurement frequency channel (step 38) to obtain a continuous sample data record equal to a “superframe.” The Sync State is rechecked (step 42) and, if Sync State ═FRAME_SYNC, then a sample index to slot 0 is computed (step 44) to return data samples and the slot 0 start index. Otherwise RF burst ramp edges are searched for (step 46) to return data samples and a slot start index, as in the prior art when there is no frame synchronization, i.e., frame synchronization failed.

Thus the present invention provides in a measurement instrument a method of synchronizing to GSM RF downlink signal frame timing by initially acquiring a continuous sample data record sufficient to encompass FC and SY bursts in consecutive frames, searching for the FC burst to determine a “coarse” location of the frame structure within the acquired sample data record, fine searching over a limited time range about a predicted position when the FC burst is found to find the SY burst which gives a precise indication of frame location, and then parsing the sample data record of a measurement frequency channel to find the desired slot to make measurements.

1. A method of synchronizing to GSM RF downlink signal frame timing comprising the steps of:
initially acquiring a continuous sample data record from a base RF channel of the RF downlink signal having a length sufficient to guarantee inclusion of a frequency burst and a synchronization burst in consecutive frames;
searching for a location of the frequency burst within the continuous sample data record; and
fine searching for a location of the synchronization burst over a limited time interval about a predicted synchronization burst location based on the frequency burst location to provide a precise frame location.

2. The method as recited in claim 1 further comprising the step of extracting data from a specified slot of any frame within the continuous sample data record based on the precise frame location for further measurement processing.

3. The method as recited in claim 1 further comprising the steps of:
acquiring a continuous sample data record from a related measurement channel; and
extracting data from a specified slot of any frame within the measurement channel continuous sample data record based on the precise frame location for further measurement processing.

4. The method as recited in claim 1 further comprising the step of repeating the fine searching step for subsequent acquisitions of continuous sample data records based on the precise frame location from a prior acquisition.
